(19) United States
(12) Patent Application Publication
(10) Pub. No.: US 2026/0162143 A1
(43) Pub. Date: Jun. 11, 2026

(54) PREDICTION METHOD AND DEVICE FOR ADVERTISEMENT DELIVERY EFFECT

(71) Applicant: Hangzhou Alibaba International Internet Industry Co., Ltd., Hangzhou City (CN)

(72) Inventors: Xiang WANG, Hangzhou (CN); Fang DONG, Hangzhou (CN); Shineng FANG, Hangzhou (CN)

(21) Appl. No.: 19/535,438

(22) Filed: Feb. 10, 2026

Related U.S. Application Data
(63) Continuation of application No. PCT/CN2024/103929, filed on Jul. 5, 2024.

(30) Foreign Application Priority Data
Aug. 29, 2023 (CN) 202311102112.3

(51) Int. Cl. G06Q 30/0242; G06Q 30/0241

(52) U.S. Cl. CPC G06Q 30/0242; G06Q 30/0277

(57) ABSTRACT

Embodiments of the present invention provide a prediction method and device for advertisement delivery effect. The method includes: obtaining a plan identifier and an estimated delivery cost corresponding to an advertisement delivery plan; determining a delivery function parameter in an advertisement delivery function and a weight function parameter in a weight function based on the plan identifier and the estimated delivery cost, where the advertisement delivery function is used to identify a relationship between the delivery cost and the delivery effect, and the weight function is used to determine a weight of the delivery effect obtained through the advertisement delivery function; and determining advertisement delivery effects respectively corresponding to different delivery costs based on the delivery function parameter, the weight function parameter, the advertisement delivery function, and the weight function before delivering the advertisement delivery plan, where the different delivery costs at least include the estimated delivery cost.

### CROSS-REFERENCE TO RELATED APPLICATIONS

This application is a Continuation application of International Patent Application No. PCT/CN2024/103929, filed on Jul. 5, 2024, which is based on and claims priority to and benefits of Chinese Patent Application No. 202311102112.3, filed with the China National Intellectual Property Administration on Aug. 29, 2023, and entitled “Method and Devise for Predicting Advertisement Delivery Effect.” The above-referenced applications are incorporated herein by reference in their entirety.

### TECHNICAL FIELD

The present invention relates to the field of network information processing, and in particular, to a prediction method and device for advertisement delivery effect.

### BACKGROUND

With the rapid development of science and technology, there are more and more ways of information promotion, and the application scope is becoming wider and wider. The main ways of information promotion may include advertisement promotion and manual promotion. Specifically, when an advertiser implements an information promotion operation by delivering advertisements to a network, in order to achieve the promotion goal or promotion purpose desired by the advertiser, the advertiser often needs to constantly modify the plan content, and then after a period of time after delivering the modified plan content, the advertisement promotion effect can be observed. When the advertisement promotion effect does not meet the requirements, it may be necessary to continue to adjust the plan content to obtain an advertisement promotion effect that meets user requirements. However, this not only brings a large trial-and-error cost to the advertiser, but also faces the risk of customer loss.

### SUMMARY

Embodiments of the present invention provide a prediction method and device for advertisement delivery effect, which can obtain the advertisement delivery effect before delivering an advertisement delivery plan, which not only reduces the trial-and-error cost of the advertiser, but also helps to improve the efficiency of the advertiser in making decisions.

In a first aspect, an embodiment of the present invention provides a prediction method for advertisement delivery effect, comprising:
obtaining a plan identifier and an estimated delivery cost corresponding to an advertisement delivery plan;
determining a delivery function parameter in an advertisement delivery function and a weight function parameter in a weight function based on the plan identifier and the estimated delivery cost, where the advertisement delivery function is used to identify a relationship between the delivery cost and the delivery effect, and the weight function is used to determine a weight of the delivery effect obtained through the advertisement delivery function;
determining advertisement delivery effects respectively corresponding to different delivery costs based on the delivery function parameter, the weight function parameter, the advertisement delivery function, and the weight function before delivering the advertisement delivery plan, where the different delivery costs at least include the estimated delivery cost.

In a second aspect, an embodiment of the present invention provides a prediction device for advertisement delivery effect, comprising:
a first obtaining module, configured to obtain a plan identifier and an estimated delivery cost corresponding to an advertisement delivery plan;
a first determining module, configured to determine a delivery function parameter in an advertisement delivery function and a weight function parameter in a weight function based on the plan identifier and the estimated delivery cost, where the advertisement delivery function is used to identify a relationship between the delivery cost and the delivery effect, and the weight function is used to determine a weight of the delivery effect obtained through the advertisement delivery function;
a first processing module, configured to determine advertisement delivery effects respectively corresponding to different delivery costs based on the delivery function parameter, the weight function parameter, the advertisement delivery function, and the weight function before delivering the advertisement delivery plan, where the different delivery costs at least include the estimated delivery cost.

In a third aspect, an embodiment of the present invention provides an electronic device, comprising: a memory and a processor; where the memory is configured to store one or more computer instructions, and where the one or more computer instructions, when executed by the processor, implement the prediction method for advertisement delivery effect in the first aspect described above.

In a fourth aspect, an embodiment of the present invention provides a computer storage medium, configured to store a computer program, where the computer program, when executed by a computer, causes the computer to implement the prediction method for advertisement delivery effect in the first aspect described above.

In a fifth aspect, an embodiment of the present invention provides a computer program product, comprising: a computer-readable storage medium storing computer instructions, where when the computer instructions are executed by one or more processors, the one or more processors are caused to perform the steps in the prediction method for advertisement delivery effect shown in the first aspect described above.

In the prediction method and device for advertisement delivery effect provided by this embodiment, by obtaining a plan identifier and an estimated delivery cost corresponding to an advertisement delivery plan, then determining a delivery function parameter in an advertisement delivery function and a weight function parameter in a weight function based on the plan identifier and the estimated delivery cost, and determining advertisement delivery effects respectively corresponding to different delivery costs based on the delivery function parameter, the weight function parameter, the advertisement delivery function, and the weight function before delivering the advertisement delivery plan, it is effectively realized that the advertisement delivery effects respectively corresponding to different delivery costs can be directly determined before delivering the advertisement delivery plan. In this way, under the premise that the user does not need to set more information such as a target group, more and clearer advertisement delivery effects can be displayed to the advertiser. The displayed advertisement delivery effects respectively corresponding to different delivery costs can not only assist the advertiser in making promotion decisions and improve the decision-making efficiency of the advertiser, but also help to promote the activity of the network and increase the revenue of the network platform, further ensuring the practicality of the method and facilitating market promotion and application.

### BRIEF DESCRIPTION OF THE DRAWINGS

To describe the technical solutions in the embodiments of the present invention or in the prior art more clearly, the following briefly introduces the accompanying drawings required for describing the embodiments or the prior art. Apparently, the accompanying drawings in the following description show some embodiments of the present invention, and a person of ordinary skill in the art may still derive other drawings from these accompanying drawings without creative efforts.

FIG. 1 is a schematic diagram of a scenario of a method for predicting advertisement delivery effect provided by an embodiment of the present invention;

FIG. 2 is a schematic flowchart of a method for predicting advertisement delivery effect provided by an embodiment of the present invention;

FIG. 3 is a schematic flowchart of determining advertisement delivery effects respectively corresponding to different delivery costs based on the delivery function parameter, the weight function parameter, the advertisement delivery function, and the weight function provided by an embodiment of the present invention;

FIG. 4 is a schematic flowchart of another prediction method for advertisement delivery effect provided by an embodiment of the present invention;

FIG. 5 is a schematic flowchart of yet another prediction method for advertisement delivery effect provided by an embodiment of the present invention;

FIG. 6 is a schematic diagram of the principle of a prediction method for advertisement delivery effect provided by an application embodiment of the present invention;

FIG. 7 is a schematic diagram of model training features provided by an application embodiment of the present invention;

FIG. 8 is a schematic structural diagram of a prediction device for advertisement delivery effect provided by an embodiment of the present invention;

FIG. 9 is a schematic structural diagram of an electronic device corresponding to the prediction device for advertisement delivery effect provided by the embodiment shown in FIG. 8.

### DETAILED DESCRIPTION

To make the objectives, technical solutions, and advantages of the embodiments of the present invention clearer, the following clearly and completely describes the technical solutions in the embodiments of the present invention with reference to the accompanying drawings in the embodiments of the present invention. Apparently, the described embodiments are some but not all of the embodiments of the present invention. All other embodiments obtained by a person of ordinary skill in the art based on the embodiments of the present invention without creative efforts shall fall within the protection scope of the present invention.

The terms used in the embodiments of the present invention are merely for the purpose of describing specific embodiments, and are not intended to limit the present invention. The singular forms “a”, “an”, and “the” used in the embodiments of the present invention and the appended claims are also intended to include plural forms, unless the context clearly indicates otherwise. “A plurality of” generally includes at least two, but does not exclude the case of including at least one.

It should be understood that the term “and/or” used herein is merely an association relationship describing associated objects, indicating that three relationships may exist. For example, A and/or B may indicate: A exists alone, both A and B exist simultaneously, and B exists alone. In addition, the character “/” herein generally indicates an “or” relationship between the associated objects.

Depending on the context, the words “if” and “suppose” as used herein may be interpreted as “when” or “upon” or “in response to determining” or “in response to detecting”. Similarly, depending on the context, the phrase “if it is determined” or “if (a stated condition or event) is detected” may be interpreted as “when it is determined” or “in response to determining” or “when (a stated condition or event) is detected” or “in response to detecting (a stated condition or event)”.

It should be further noted that the terms “comprise”, “include”, or any other variants thereof are intended to cover a non-exclusive inclusion, so that a commodity or system including a series of elements not only includes those elements, but also includes other elements not expressly listed, or also includes elements inherent to such a commodity or system. Without further limitation, an element defined by the statement “comprising a . . . ” does not exclude the presence of another same element in the commodity or system including the element.

In addition, the sequence of steps in the following method embodiments is merely an example, and is not strictly limited.

### Term Definition

ctr: click through rate, advertisement click-through rate.
ocpc: optimized cost per click, an intelligent bidding method targeting conversion. Different from CPC bidding, ocpc gives different bids according to the current advertisement conversion rate.
bid: advertisement bid for a single request, which gives different bids for different requests according to traffic value.

To facilitate understanding of the specific implementation process and implementation effects of the prediction method and device for advertisement delivery effect in this embodiment, the related art is briefly described below:

With the rapid development of science and technology, there are more and more ways of information promotion, and the application scope is becoming wider and wider. The main ways of information promotion may include advertisement promotion and manual promotion. Specifically, when an advertiser implements an information promotion operation by delivering advertisements to a network, in order to achieve the promotion goal or promotion purpose desired by the advertiser, the advertiser often needs to constantly modify the plan content, and then after a period of time after delivering the modified plan content, the advertisement promotion effect can be observed. When the advertisement promotion effect does not meet the requirements, it may be necessary to continue to adjust the plan content to obtain an advertisement promotion effect that meets user requirements. However, this not only brings a large trial-and-error cost to the advertiser, but also faces the risk of customer loss.

To solve the above technical problems, a method for estimating advertisement effect is proposed in the related art. Specifically, this method requires the advertiser to first determine information such as the target user group and target time period to be delivered, and then the effect estimation can be performed based on the determined target user group and target time period. In this case, the advertiser needs to input a lot of information, thereby reducing the good user experience.

In other examples, the related art provides another method for estimating advertisement effect. This method completely implements the advertisement effect estimation operation by a pre-trained network model. Since the advertisement effect estimation operation process does not consider the monotonicity of advertisement bid and budget on the advertisement effect, abnormal results such as higher budget and less exposure are likely to occur, which greatly reduces the accuracy of estimating the advertisement effect.

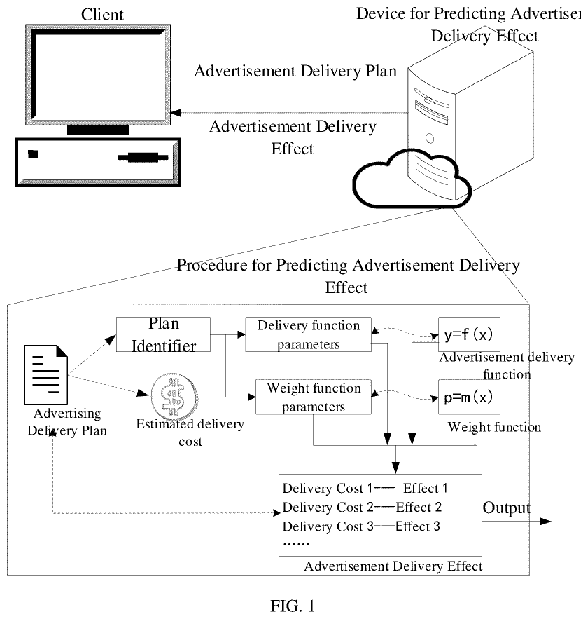

In order to solve the above technical problems, this embodiment provides a method and device for predicting advertisement delivery effect. Referring to FIG. 1, the execution subject of the method for predicting advertisement delivery effect may be a device for predicting advertisement delivery effect. It should be noted that the device for predicting advertisement delivery effect may be implemented as a local server or a cloud server. In this case, the method for predicting advertisement delivery effect may be executed in the cloud. Several computing nodes (cloud servers) may be deployed in the cloud, and each computing node has processing resources such as calculation and storage. In the cloud, multiple computing nodes may be organized to provide a certain service. Of course, one computing node may also provide one or more services. The way the cloud provides the service may be to provide a service interface externally, and a user invokes the service interface to use the corresponding service. The service interface includes forms such as a Software Development Kit (abbreviated as SDK), an Application Programming Interface (abbreviated as API), etc.

The device for predicting advertisement delivery effect may be communicatively connected to a client, where the client is used for advertiser users to apply to implement the operation of determining advertisement delivery effect. The above client may be any computing device with certain data transmission capabilities. In specific implementation, the client may be a mobile phone, a personal computer (PC), a tablet computer, a set application, etc. In addition, the basic structure of the client may include: at least one processor. The number of processors depends on the configuration and type of the client. The client may also include a memory, and the memory may be volatile, such as Random Access Memory (abbreviated as RAM), or may be non-volatile, such as Read-Only Memory (Read-Only Memory, abbreviated as ROM), flash memory, etc., or may also include both types. An operating system (Operating System, abbreviated as OS), one or more applications are usually stored in the memory, and program data, etc., may also be stored. In addition to the processing unit and the memory, the client further includes some basic configurations, such as a network card chip, an IO bus, a display component, and some peripheral devices. Optionally, some peripheral devices may include, for example, a keyboard, a mouse, a stylus, a printer, etc. Other peripheral devices are well known in the art and will not be described in detail here.

The device for predicting advertisement delivery effect refers to a device that can provide an operation of determining advertisement delivery effect in a network virtual environment, and usually refers to a device that uses a network to perform information planning and the operation of determining advertisement delivery effect. In terms of physical implementation, the device for predicting advertisement delivery effect may be any device capable of providing computing services, responding to a request for determining advertisement delivery effect, and performing the operation of determining advertisement delivery effect based on the request for determining advertisement delivery effect, for example: it may be a cluster server, a conventional server, a cloud server, a cloud host, a virtual center, etc. The composition of the device for predicting advertisement delivery effect mainly includes a processor, a hard disk, a memory, a system bus, etc., which is similar to a general-purpose computer architecture.

In the above embodiment, the client is connected to the prediction device for advertisement delivery effect via a network, and the network connection may be a wireless or wired network connection. If the client is communicatively connected to the prediction device for advertisement delivery effect, the network standard of the mobile network may be any one of 2G (GSM), 2.5G (GPRS), 3G (WCDMA, TD-SCDMA, CDMA2000, UTMS), 4G (LTE), 4G+ (LTE+), WiMax, 5G, 6G, etc.

In the embodiment of the present application, the client is used for the advertiser user to use to implement the determination operation of the advertisement delivery effect. Specifically, when the advertiser user has a determination requirement for the advertisement delivery effect, a determination request for the advertisement delivery effect can be generated. The determination request for the advertisement delivery effect may include one or more advertisement delivery plans to be analyzed. For each advertisement delivery plan, in order to implement the determination operation of the advertisement delivery effect, the determination request for the advertisement delivery effect can be sent to the prediction device for advertisement delivery effect.

The prediction device for advertisement delivery effect is configured to receive the determination request for the advertisement delivery effect sent by the client, and then obtain a plan identifier and an estimated delivery cost corresponding to the advertisement delivery plan based on the determination request for the advertisement delivery effect, where the estimated delivery cost may include at least one of the following: an estimated delivery budget and an estimated delivery bid. The above estimated delivery budget is the fee that the user needs to pay for one day of advertisement promotion operation, for example: 10,000/day, 100,000/day, or 200,000/day, etc. The estimated delivery bid is the price set by the advertiser that needs to be paid for a user clicking on the advertisement once, for example: 8 yuan/time, 10 yuan/time, 15 yuan/time, 20 yuan/time, etc.

Specifically, an advertisement delivery function and a weight function for determining the advertisement delivery effect are pre-configured in the prediction device for advertisement delivery effect, where the advertisement delivery function is used to identify a relationship between the delivery cost and the delivery effect, and the weight function is used to determine a weight of the delivery effect obtained through the advertisement delivery function. For the advertisement delivery function and the weight function, the advertisement delivery function includes one or more delivery function parameters to be determined, and the weight function includes a weight function parameter to be determined. Since the delivery function parameter and the weight function parameter are related to the estimated delivery cost and the advertisement delivery plan corresponding to the advertisement delivery plan, after obtaining the plan identifier and the estimated delivery cost, the delivery function parameter in the advertisement delivery function and the weight function parameter in the weight function can be determined based on the plan identifier and the estimated delivery cost.

Since the advertisement delivery function and the weight function can be used to determine the advertisement delivery effect, before delivering the advertisement delivery plan, in order to accurately determine the advertisement delivery effect, after determining the delivery function parameter, the weight function parameter, the advertisement delivery function, and the weight function, the delivery function parameter, the weight function parameter, the advertisement delivery function, and the weight function can be analyzed and processed to determine advertisement delivery effects respectively corresponding to different delivery costs. The different delivery costs include at least one of the following: a first type of cost greater than the estimated delivery cost, a second type of cost less than the estimated delivery cost, and the estimated delivery cost. It should be noted that the delivery cost is positively correlated with the advertisement delivery effect, that is, the advertisement delivery effect corresponding to the first type of cost is greater than the advertisement delivery effect corresponding to the estimated delivery cost, and the advertisement delivery effect corresponding to the estimated delivery cost is greater than the advertisement delivery effect corresponding to the second type of cost.

The technical solution provided by this embodiment effectively realizes that the advertisement delivery effects respectively corresponding to different delivery costs can be directly determined before delivering the advertisement delivery plan. In this way, under the premise that the user does not need to set more information such as a target group, more and clearer advertisement delivery effects can be displayed to the advertiser. The displayed advertisement delivery effects respectively corresponding to different delivery costs can not only assist the advertiser in making promotion decisions and improve the decision-making efficiency of the advertiser, but also help to promote the activity of the network and increase the revenue of the network platform, further ensuring the practicality of the method.

The following describes some embodiments of the present invention in detail with reference to the accompanying drawings. In the case of no conflict between the embodiments, the following embodiments and the features in the embodiments may be combined with each other. In addition, the sequence of steps in the following method embodiments is merely an example, and is not strictly limited.

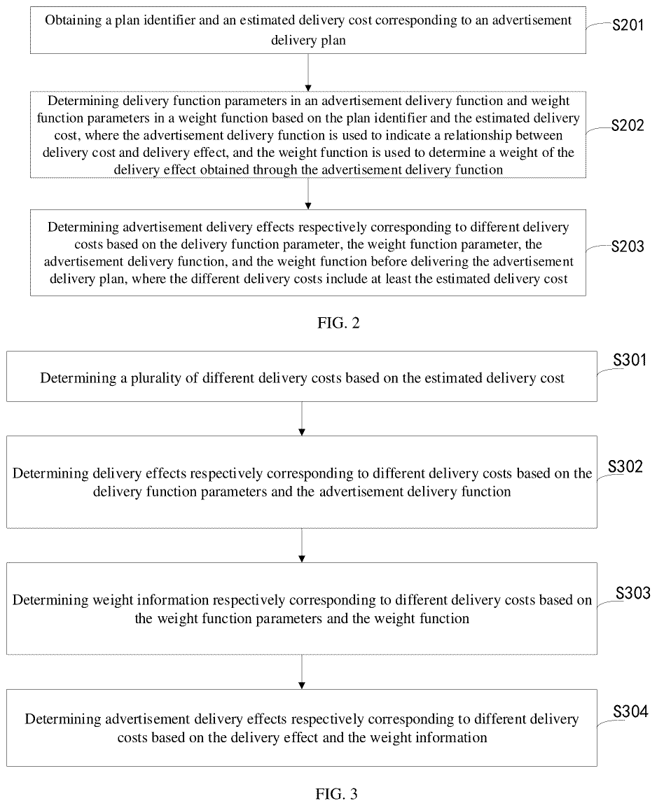

FIG. 2 is a schematic flowchart of a method for predicting advertisement delivery effect provided by an embodiment of the present invention; referring to FIG. 2, this embodiment provides a method for predicting advertisement delivery effect. The execution subject of the method is a device for predicting advertisement delivery effect. It can be understood that the device for predicting advertisement delivery effect may be implemented as software, or a combination of software and hardware. Specifically, when the device for predicting advertisement delivery effect is implemented as hardware, it may specifically be various electronic devices capable of the operation of determining advertisement delivery effect, including but not limited to personal computers, servers, etc. When the device for determining advertisement delivery effect is implemented as software, it may be installed in the electronic devices exemplified above. Based on the above device for predicting advertisement delivery effect, the method for predicting advertisement delivery effect may include:

Step S201: obtaining a plan identifier and an estimated delivery cost corresponding to an advertisement delivery plan.

Step S202: determining delivery function parameters in an advertisement delivery function and weight function parameters in a weight function based on the plan identifier and the estimated delivery cost, where the advertisement delivery function is used to indicate a relationship between delivery cost and delivery effect, and the weight function is used to determine a weight of the delivery effect obtained through the advertisement delivery function.

Step S203: determining advertisement delivery effects respectively corresponding to different delivery costs based on the delivery function parameter, the weight function parameter, the advertisement delivery function, and the weight function before delivering the advertisement delivery plan, where the different delivery costs include at least the estimated delivery cost.

The specific implementation process and implementation effects of the above steps are described in detail below:

Step S201: obtaining a plan identifier and an estimated delivery cost corresponding to an advertisement delivery plan.

Here, in the process of or after the advertiser configures the advertisement delivery plan, the configured advertisement delivery plan may correspond to a plan identifier, and the plan identifier is used as a unique identifier id of the advertisement delivery plan, that is, different advertisement delivery plans may correspond to different plan identifiers. In order to determine the advertisement delivery effect before placing the advertisement delivery plan, the device for predicting advertisement delivery effect may be enabled to obtain the plan identifier and the estimated delivery cost corresponding to the advertisement delivery plan in the process of or after the advertiser configures the advertisement delivery plan. In some examples, the estimated delivery cost may include at least one of the following: an estimated delivery budget and an estimated delivery bid. The estimated delivery budget is the fee that the user needs to pay when performing a one-day advertisement promotion operation, a 1-week advertisement promotion operation, or a 1-month advertisement promotion operation, for example: 1 ten thousand/day, 10 ten thousand/day, 20 ten thousand/day, 80 ten thousand/week, 100 ten thousand/week, etc. The estimated delivery bid is the price that the user needs to pay for clicking the advertisement once set or pre-configured by the advertiser, for example: 8 yuan/time, 10 yuan/time, 15 yuan/time, 20 yuan/time, etc.

In some examples, the plan identifier and the estimated delivery cost corresponding to the advertisement delivery plan may be obtained through a human-computer interaction operation. In this case, obtaining the plan identifier and the estimated delivery cost corresponding to the advertisement delivery plan may include: displaying an interaction interface for configuring the advertisement delivery plan; obtaining a parameter configuration operation input by a user on the interaction interface; and obtaining the plan identifier and the estimated delivery cost corresponding to the advertisement delivery plan based on the parameter configuration operation.

In other examples, the plan identifier and the estimated delivery cost may be obtained not only through the human-computer interaction operation but also through a client. In this case, obtaining the plan identifier and the estimated delivery cost corresponding to the advertisement delivery plan may include: obtaining a client communicatively connected to the device for predicting advertisement delivery effect, and determining the advertisement delivery plan stored in the client; and obtaining the advertisement delivery plan actively or passively through the client, and then determining the estimated delivery cost and the plan identifier based on the advertisement delivery plan, thereby effectively ensuring the accuracy and reliability of obtaining the estimated delivery cost and the plan identifier.

Step S202: determining delivery function parameters in an advertisement delivery function and weight function parameters in a weight function based on the plan identifier and the estimated delivery cost, where the advertisement delivery function is used to indicate a relationship between delivery cost and delivery effect, and the weight function is used to determine a weight of the delivery effect obtained through the advertisement delivery function.

The device for predicting advertisement delivery effect is configured with an advertisement delivery function and a weight function for determining the advertisement delivery effect. The above advertisement delivery function is used to indicate the relationship between the delivery cost and the delivery effect, and the weight function is used to determine the weight of the delivery effect obtained through the advertisement delivery function. For the advertisement delivery function, it may be a monotonic function indicating a positive correlation between the delivery cost and the delivery effect. For example, the advertisement delivery function may be expressed as y=ax+b, y=e^{ax+b}, etc. In the above formulas, y is the delivery effect, x is the delivery cost, and a and b are preset parameters. That is, the delivery function parameters in the advertisement delivery function may include a first parameter a for limiting an upper limit value of the delivery effect and a second parameter b for limiting a rate of change of the advertisement delivery function. The delivery cost includes at least one of the following: a delivery budget and a delivery bid. The delivery effect may include at least one of the following: an exposure amount, a click amount, and a consumption amount.

It should be noted that, since the delivery effect may include the exposure amount, the click amount, and the consumption amount, the delivery function parameters in the advertisement delivery function corresponding to different delivery effects may be the same or different. For example, the exposure amount function may be expressed as: y1=a1*x+b1, or y1=e^{a1*x+b1}, where the above a1 and b1 may be the first parameter and the second parameter corresponding to the exposure amount function respectively, y1 is the exposure amount, and x is the estimated delivery cost. Similarly, the click amount function may be expressed as: y2=a2*x+b2, or y2=e^{a2*x+b2}, where the above a2 and b2 may be the first parameter and the second parameter corresponding to the click amount function respectively, y2 is the click amount, and x is the estimated delivery cost. The consumption amount function may be expressed as: y3=a3*x+b3, or y3=e^{a3*x+b3}, where the above a3 and b3 may be the first parameter and the second parameter corresponding to the consumption amount function respectively, y3 is the consumption amount, and x is the estimated delivery cost. The above parameters (a1, b1), (a2, b2), and (a3, b3) may be the same or different.

For the weight function, it may be a piecewise function used to determine the delivery effect obtained through the advertisement delivery function. For example, when the delivery cost is low, the first segment function of the weight function may be expressed as

$$f = \frac{x}{max} ,$$

where ƒ is the weight information, max is the preset maximum consumption, and x is the delivery cost. When the delivery cost is high, the second segment function of the weight function may be expressed as

$$f = 1 + c ( 1 - \frac{max}{x} ) ,$$

where ƒ is the weight information, max is the preset maximum consumption, c is a preset parameter, and x is the delivery cost. Obviously, the first segment function is different from the second segment function. In this case, the weight function parameters may include a third parameter c for limiting an upper limit value of the weight.

Since the advertisement delivery function includes delivery function parameters that need to be determined (for example: a, b), and the weight function includes weight function parameters that need to be determined (for example: c), in order to determine the delivery effect of the advertisement delivery plan before placing the advertisement delivery plan, the delivery function parameters in the advertisement delivery function and the weight function parameters in the weight function may be determined based on the plan identifier and the estimated delivery cost after obtaining the plan identifier and the estimated delivery cost of the advertisement delivery plan. In some examples, the delivery function parameters and the weight function parameters may be obtained through a pre-trained machine learning model or neural network model. In this case, determining the delivery function parameters in the advertisement delivery function and the weight function parameters in the weight function based on the plan identifier and the estimated delivery cost may include: obtaining a pre-trained machine learning model or neural network model; inputting the plan identifier and the planned delivery cost into the machine learning model or neural network model; and obtaining the delivery function parameters in the advertisement delivery function and the weight function parameters in the weight function output by the machine learning model or neural network model.

In other examples, the delivery function parameters and the weight function parameters may be obtained not only through the pre-trained machine learning model or neural network model but also through offline features corresponding to the advertisement delivery plan. In this case, determining the delivery function parameters in the advertisement delivery function and the weight function parameters in the weight function based on the plan identifier and the estimated delivery cost may include: determining offline features corresponding to the advertisement delivery plan based on the plan identifier, where the offline features include: plan attributes, plan historical effects, and user attributes; and determining the delivery function parameters in the advertisement delivery function and the weight function parameters in the weight function based on the estimated delivery cost and the offline features.

Specifically, for advertisement delivery plans, different advertisement delivery plans may correspond to different plan features. For example, the identity types of advertisers corresponding to different advertisement delivery plans are different, the target user groups corresponding to different advertisement delivery plans are different, the plan types corresponding to different advertisement delivery plans are different, etc. Since the plan features corresponding to different advertisement delivery plans can have different influences on the delivery function parameters in the advertisement delivery function and the weight function parameters in the weight function, in order to accurately determine the delivery function parameters in the advertisement delivery function and the weight function parameters in the weight function, the offline features corresponding to the advertisement delivery plan may be determined based on the plan identifier after obtaining the plan identifier. The offline features may include plan attributes, plan historical effects, and user attributes. In some examples, the plan attributes may include at least one of the following: a plan type, a bid type, a number of products, and a number of keywords. The above plan type may include: a new product plan, a hot product plan, an ordinary product plan, a keyword plan, etc. The bid type may include: an industry intelligent bid, a merchant manual bid, a keyword bid, a target cost bid, etc.

For the plan historical effects, they may include plan effect data and category effect data. The above plan effect data may include at least one of the following: a number of exposures in the last 7 days in historical data, a number of clicks in the last 7 days, a number of clicks by preset type users in the last 7 days, a consumption amount in the last 7 days, etc. The category effect data may include at least one of the following: an average number of exposures per product under a second-level category, an average consumption amount per product under a second-level category, an average number of exposures per product under a third-level category, an average consumption amount per product under a third-level category, etc. In addition, the user attributes may include registration years of the advertiser, a star level of the advertiser, an advertiser level, etc. The above user attributes may be obtained through an identity identifier of the advertiser corresponding to the advertisement delivery plan. Specifically, in the process of or after obtaining the advertisement delivery plan, the identity identifier of the advertiser may be obtained first; and the user attributes are determined based on the identity identifier of the advertiser.

After obtaining the estimated delivery cost and the offline features may be analyzed and processed, so that the delivery function parameters in the advertisement delivery function and the weight function parameters in the weight function can be determined. In some examples, the analysis and processing of the estimated delivery cost and the offline features may be implemented through a pre-trained neural network model. In this case, determining the delivery function parameters in the advertisement delivery function and the weight function parameters in the weight function based on the estimated delivery cost and the offline features may include: obtaining a pre-trained neural network model; and processing the estimated delivery cost and the offline features using the neural network model to obtain the delivery function parameters in the advertisement delivery function and the weight function parameters in the weight function.

In still other examples, before obtaining the pre-trained neural network model, this embodiment may further include a training process of the neural network model. In this case, the method in this embodiment may further include: obtaining historical delivery information corresponding to a historical advertisement delivery plan and a historical delivery effect corresponding to the historical delivery information; adjusting the historical delivery information to obtain adjusted delivery information, specifically, the historical delivery information may be adjusted down and adjusted up to obtain adjusted-down delivery information and adjusted-up delivery information; after obtaining the adjusted delivery information, analyzing and processing the adjusted delivery information to determine a simulated delivery effect corresponding to the adjusted delivery information; and then performing a model training operation based on the historical delivery information, the historical delivery effect, the adjusted delivery information, and the simulated delivery effect, so as to obtain a neural network model for determining the delivery function parameter in the advertisement delivery function and the weight function parameter in the weight function. In some examples, the obtained neural network model is a multi-task learning model.

Step S203: determining advertisement delivery effects respectively corresponding to different delivery costs based on the delivery function parameters, the weight function parameters, the advertisement delivery function, and the weight function before placing the advertisement delivery plan, where the different delivery costs at least include the estimated delivery cost.

After obtaining the delivery function parameter and the weight function parameter, before delivering the advertisement delivery plan, the delivery function parameter, the weight function parameter, the advertisement delivery function, and the weight function can be analyzed and processed to determine advertisement delivery effects respectively corresponding to different delivery costs. It should be noted that the different delivery costs at least include the estimated delivery cost. For example: the estimated delivery cost included in the advertisement delivery plan is 1000,000. Through the analysis and processing of the estimated delivery cost and the plan identifier, the advertisement delivery effect corresponding to delivering a promotion budget of 1000,000 can be predicted and determined. In other examples, the different delivery costs may further include: the estimated delivery cost and other costs different from the estimated delivery cost. The other costs may include at least one of the following: a first type of cost greater than the preset delivery cost, and a second type of cost less than the estimated delivery cost. For example, the estimated delivery cost included in the advertisement delivery plan is 1000,000. Through the analysis and processing of the estimated delivery cost and the plan identifier, the advertisement delivery effect corresponding to delivering a promotion budget of 1000,000, the advertisement delivery effect corresponding to delivering a promotion budget of 2000,000, the advertisement delivery effect corresponding to delivering a promotion budget of 3000,000, etc., can be predicted and determined; or, the advertisement delivery effect corresponding to delivering a promotion budget of 1000,000, the advertisement delivery effect corresponding to delivering a promotion budget of 500,000, the advertisement delivery effect corresponding to delivering a promotion budget of 1500,000, the advertisement delivery effect corresponding to delivering a promotion budget of 2000,000, etc., can be predicted and determined; or, the advertisement delivery effect corresponding to delivering a promotion budget of 1000,000, the advertisement delivery effect corresponding to delivering a promotion budget of 500,000, the advertisement delivery effect corresponding to delivering a promotion budget of 800,000, the advertisement delivery effect corresponding to delivering a promotion budget of 900,000, etc., can be predicted and determined. Since there is a positive correlation between the delivery cost and the advertisement delivery effect, when the advertisement delivery effect corresponding to the first type of cost and the advertisement delivery effect corresponding to the estimated delivery cost can be predicted and determined, the advertisement delivery effect corresponding to the first type of cost is greater than the advertisement delivery effect corresponding to the estimated delivery cost; when the advertisement delivery effect corresponding to the estimated delivery cost and the advertisement delivery effect corresponding to the second type of cost can be predicted and determined, the advertisement delivery effect corresponding to the estimated delivery cost is greater than the advertisement delivery effect corresponding to the second type of cost.

In some examples, the advertisement delivery effects respectively corresponding to different delivery costs can be obtained by analyzing and processing the delivery function parameter, the weight function parameter, the advertisement delivery function, and the weight function through a pre-trained machine learning model. In this case, determining the advertisement delivery effects respectively corresponding to different delivery costs based on the delivery function parameter, the weight function parameter, the advertisement delivery function, and the weight function may include: obtaining a pre-trained neural network model, inputting the delivery function parameter, the weight function parameter, the advertisement delivery function, and the weight function into the neural network model, and obtaining the advertisement delivery effects respectively corresponding to different delivery costs output by the neural network model, thereby effectively ensuring the accuracy and reliability of obtaining the advertisement delivery effects respectively corresponding to different delivery costs.

In the prediction method for advertisement delivery effect provided by this embodiment, by obtaining a plan identifier and an estimated delivery cost corresponding to an advertisement delivery plan, then determining a delivery function parameter in an advertisement delivery function and a weight function parameter in a weight function based on the plan identifier and the estimated delivery cost, and determining advertisement delivery effects respectively corresponding to different delivery costs based on the delivery function parameter, the weight function parameter, the advertisement delivery function, and the weight function before delivering the advertisement delivery plan, it is effectively realized that the advertisement delivery effects respectively corresponding to different delivery costs can be directly determined before delivering the advertisement delivery plan. In this way, under the premise that the user does not need to set more information such as a target group, more and clearer advertisement delivery effects can be displayed to the advertiser. The displayed advertisement delivery effects respectively corresponding to different delivery costs can not only assist the advertiser in making promotion decisions and improve the decision-making efficiency of the advertiser, but also help to promote the activity of the network and increase the revenue of the network platform, further ensuring the practicality of the method and facilitating market promotion and application.

FIG. 3 is a schematic flowchart of determining advertisement delivery effects respectively corresponding to different delivery costs based on delivery function parameters, weight function parameters, an advertisement delivery function, and a weight function provided by an embodiment of the present invention; based on the above embodiment, referring to FIG. 3, the advertisement delivery effects respectively corresponding to different delivery costs may be obtained not only through a pre-trained machine learning model or neural network model but also by directly analyzing and processing the delivery function parameters, the advertisement delivery function, the weight function, and the weight function parameters. In this case, determining the advertisement delivery effects respectively corresponding to different delivery costs based on the delivery function parameters, the weight function parameters, the advertisement delivery function, and the weight function may include:

Step S301: determining a plurality of different delivery costs based on the estimated delivery cost.

Here, since one advertisement delivery plan often corresponds to one estimated delivery cost, and the estimated delivery cost is the advertisement delivery cost that the user needs to pay or is estimated to invest in the process of performing the promotion operation. In order to obtain the advertisement delivery effects respectively corresponding to different delivery costs, after obtaining the estimated delivery cost, the estimated delivery cost may be analyzed and processed to determine a plurality of different delivery costs. In some examples, determining a plurality of different delivery costs based on the estimated delivery cost may include: obtaining a magnitude parameter for adjusting the estimated delivery cost, where the magnitude parameter may be a pre-configured default parameter or an adjustment parameter input by the user, for example: the magnitude parameter may be 10%, 20%, 30%, etc. After obtaining the magnitude parameter, the estimated delivery cost may be increased and decreased based on the magnitude parameter, so that a plurality of different delivery costs can be obtained. It should be noted that the plurality of different delivery costs may include not only a first type of cost greater than the estimated delivery cost and a second type of cost less than the estimated delivery cost, but also the estimated delivery cost.

Step S302: determining delivery effects respectively corresponding to different delivery costs based on the delivery function parameters and the advertisement delivery function.

After obtaining the delivery function parameters and the advertisement delivery function, the delivery function parameters and the advertisement delivery function may be analyzed and processed, so that the delivery effects respectively corresponding to different delivery costs can be determined. For example, when the advertisement delivery function is y1=a1*x+b1, after obtaining the delivery function parameters (a1, b1) and obtaining the different delivery costs (x, x2, x3 . . . ), the delivery function parameters and the different delivery costs may be substituted into the advertisement delivery function, so that the delivery effects y1 respectively corresponding to different delivery costs can be determined. The delivery effects y1 respectively corresponding to different delivery costs may include: a delivery effect y11 corresponding to x, a delivery effect y12 corresponding to x2, a delivery effect y13 corresponding to x3, etc., thereby effectively ensuring the accuracy and reliability of determining the delivery effects respectively corresponding to different delivery costs.

Step S303: determining weight information respectively corresponding to different delivery costs based on the weight function parameters and the weight function.

After obtaining the weight function parameters and the weight function, the weight function parameters and the weight function may be analyzed and processed, so that the weight information respectively corresponding to different delivery costs can be determined. For example, when the weight function is

$$f = 1 + c ( 1 - \frac{max}{x} ) ,$$

after obtaining the weight function parameter c, and obtaining the different delivery costs (x, x2, x3 . . . ) and the estimated maximum consumption max, the weight function parameter, the different delivery costs, and the maximum consumption max may be substituted into the weight function, so that the weight information ƒ respectively corresponding to different delivery costs can be determined. The weight information ƒ respectively corresponding to different delivery costs may include: a delivery effect ƒ11 corresponding to x, a delivery effect ƒ12 corresponding to x2, a delivery effect ƒ13 corresponding to x3, etc., thereby effectively ensuring the accuracy and reliability of determining the weight information respectively corresponding to different delivery costs.

Step S304: determining advertisement delivery effects respectively corresponding to different delivery costs based on the delivery effect and the weight information.

After obtaining the delivery effect and the weight information respectively corresponding to different delivery costs, the delivery effect and the weight information may be analyzed and processed to determine the advertisement delivery effects respectively corresponding to different delivery costs. In some examples, determining the advertisement delivery effects respectively corresponding to different delivery costs based on the delivery effect and the weight information may include: determining a product value of the delivery effect and the weight information corresponding to different delivery costs as the advertisement delivery effects respectively corresponding to different delivery costs.

For example, when the delivery effects corresponding to different delivery costs are y11, y12, y13, and the weight information respectively corresponding to different delivery costs are ƒ11, ƒ12, ƒ13, the product values between the delivery effects and the weight information corresponding to different delivery costs may be obtained. The product values may be: y11*ƒ11, y12*ƒ12, y13*ƒ13, etc. After obtaining the above product values, the product values of the delivery effects and the weight information corresponding to different delivery costs may be directly determined as the advertisement delivery effects respectively corresponding to different delivery costs, thereby effectively ensuring the accuracy and reliability of determining the advertisement delivery effect.

In still other examples, the advertisement delivery effects respectively corresponding to different delivery costs may be determined not only through the delivery effect and the weight information but also by combining other auxiliary parameters. In this case, determining the advertisement delivery effects respectively corresponding to different delivery costs based on the delivery effect and the weight information may include: obtaining delivery auxiliary parameters corresponding to the advertisement delivery plan, where the delivery auxiliary parameters include at least one of the following: a delivery time parameter, a delivery region parameter, and a delivery crowd parameter; and determining a product value among the delivery effect, the weight information, and the delivery auxiliary parameters respectively corresponding to different delivery costs as the advertisement delivery effects respectively corresponding to different delivery costs.

Specifically, in order to accurately obtain the advertisement delivery effects respectively corresponding to different delivery costs, the delivery auxiliary parameters corresponding to the advertisement delivery plan may be obtained. The above delivery auxiliary parameters may be stored in a preset device or a preset area. In this case, the delivery auxiliary parameters corresponding to the advertisement delivery plan may be obtained by accessing the preset device or the preset area. The delivery auxiliary parameters include at least one of the following: a delivery time parameter, a delivery region parameter, and a delivery crowd parameter. In some examples, the delivery auxiliary parameters may be one-dimensional parameters. For example, when the delivery auxiliary parameter is the delivery time parameter, it may be expressed as

$$( \begin{matrix}t 1 \\ t 2 \\ t 3 \\ tn\end{matrix} ) ,$$

where the above t1, t2, and t3, tn are used to identify different time points or time periods. When the delivery auxiliary parameter is the delivery region parameter, it may be expressed as

$$( \begin{matrix}c 1 \\ c 2 \\ c 3 \\ cn\end{matrix} ) ,$$

where the above c1, c2, and c3, cn are used to identify different countries or different regions. When the delivery auxiliary parameter is the delivery crowd parameter, it may be expressed as

$$( \begin{matrix}p 1 \\ p 2 \\ p 3 \\ pn\end{matrix} ) ,$$

where the above p1, p2, and p3, pn are used to identify different types of crowds.

After obtaining the delivery effect, the weight information, and the delivery auxiliary parameters respectively corresponding to different delivery costs, a product value among the delivery effect, the weight information, and the delivery auxiliary parameters respectively corresponding to different delivery costs may be obtained, and then the above product value may be determined as the advertisement delivery effects respectively corresponding to different delivery costs.

For example, when the delivery effects corresponding to different delivery costs are y11, y12, y13, the weight information respectively corresponding to different delivery costs are ƒ11, ƒ12, ƒ13, and the delivery auxiliary parameter is

$$( \begin{matrix}t 1 \\ t 2 \\ t 3 \\ tn\end{matrix} ) ,$$

the product values among the delivery effect, the weight information, and the delivery auxiliary parameters corresponding to different delivery costs may be obtained. The product values may include:

$$y 11 * f 11 * ( \begin{matrix}t 1 \\ t 2 \\ t 3 \\ tn\end{matrix} ) , y 12 * f 12 * ( \begin{matrix}t 1 \\ t 2 \\ t 3 \\ tn\end{matrix} ) , y 13 * f 13 * ( \begin{matrix}t 1 \\ t 2 \\ t 3 \\ tn\end{matrix} ) ,$$

etc. After obtaining the above product values, the above product values may be directly determined as the advertisement delivery effects respectively corresponding to different delivery costs, thereby effectively ensuring the flexibility and reliability of determining the advertisement delivery effect.

After obtaining the advertisement delivery effect, the advertisement delivery effect may be displayed with more fine-grained results in dimensions such as country, time period, and crowd. For example, if it is estimated that the total exposure amount of an advertisement plan in one day is 100 times, and the distribution in time is 30% in the morning, 40% in the afternoon, and 30% in the evening, then the results that the advertisement plan has 30 exposures in the morning, 40 exposures in the afternoon, and 30 exposures in the evening can be known, so that the advertiser can more clearly understand the advertisement delivery effect in each dimension.

In this embodiment, multiple different delivery costs are determined through the estimated delivery cost, delivery effects respectively corresponding to the different delivery costs are determined based on the delivery function parameter and the advertisement delivery function, and weight information respectively corresponding to the different delivery costs is determined based on the weight function parameter and the weight function. Then, the advertisement delivery effects respectively corresponding to the different delivery costs are determined based on the delivery effects and the weight information, thereby effectively ensuring the stability and reliability of determining the advertisement delivery effect, and ensuring the flexibility and reliability of determining the advertisement delivery effect.

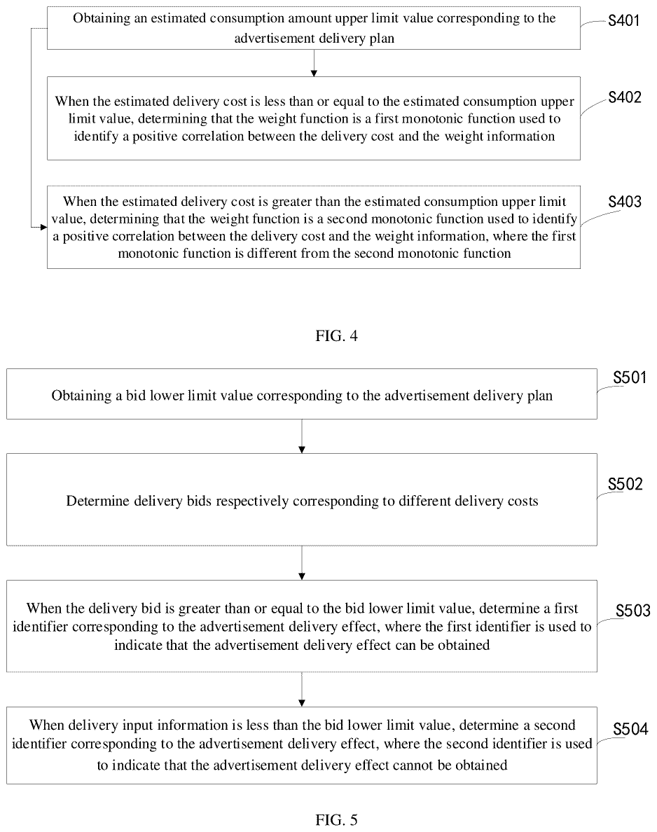

FIG. 4 is a schematic flowchart of another method for predicting advertisement delivery effect provided by an embodiment of the present invention; based on the above embodiment, referring to FIG. 4, the weight function in this embodiment is a piecewise function, which may specifically have different forms based on different delivery costs. Specifically, the method in this embodiment may further include:

Step S401: obtaining an estimated consumption amount upper limit value corresponding to the advertisement delivery plan.

For the weight function, the forms of the weight function corresponding to different levels of delivery costs are different. In order to accurately determine the specific form of the weight function, the estimated consumption amount upper limit value used for analyzing and processing the delivery cost may be obtained first. The above estimated consumption amount upper limit value is used to indicate the upper limit value of the estimated consumption amount, and the estimated consumption amount is the estimated actual delivery consumption fee. For example, the delivery cost may include a delivery budget and a delivery bid, where the delivery budget may be ten thousand/day, and the delivery bid is 10 yuan/time. By analyzing and processing historical advertisement delivery plans, it can be determined that the estimated consumption amount upper limit value may be 8 thousand/day.

Specifically, for the estimated consumption amount upper limit value, different methods may be used to obtain the estimated consumption amount upper limit value in different application scenarios. In some examples, the advertisement delivery plan may include the estimated consumption amount upper limit value. Specifically, after obtaining the advertisement delivery plan, an information extraction operation may be performed on the advertisement delivery plan, so that the estimated consumption amount upper limit value corresponding to the advertisement delivery plan can be obtained.

In other examples, the advertisement delivery plan may not include the estimated consumption amount upper limit value. In this case, the estimated consumption amount upper limit value may be obtained through a consumption amount function. Specifically, obtaining the estimated consumption amount upper limit value corresponding to the advertisement delivery plan may include: obtaining a consumption amount function corresponding to the advertisement delivery plan and function parameters corresponding to the consumption amount function; and determining the estimated consumption amount upper limit value corresponding to the advertisement delivery plan based on the consumption amount function, the function parameters, and the estimated delivery cost.

Since the estimated consumption upper limit value is related to the consumption function, in order to accurately obtain the estimated consumption upper limit value, a consumption function corresponding to the advertisement delivery plan and a function parameter corresponding to the consumption function can be obtained. After obtaining the consumption function and the function parameter, the estimated consumption upper limit value corresponding to the advertisement delivery plan can be determined in combination with the estimated delivery cost obtained in the above embodiment. For example, when the consumption function is

$$y\_cost = {e}^{a - \frac{b}{x}} ,$$

where y_cost is the estimated consumption, a and b are function parameters corresponding to the consumption function, and x is the estimated delivery cost, multiple function parameters corresponding to the consumption function can be determined through the method steps in the above embodiment, for example: (a1, b1), (a2, b2), (a3, b3) . . . . After obtaining the multiple function parameters, the multiple function parameters and the estimated delivery cost can be substituted into the consumption function, so that multiple estimated consumptions can be obtained, for example: y_cost1 corresponding to (a1, b1), y_cost2 corresponding to (a2, b2), y_cost3 corresponding to (a3, b3) . . . . Then, the multiple estimated consumptions can be analyzed and compared to obtain the estimated consumption upper limit value, thereby effectively ensuring the accuracy and reliability of obtaining the estimated consumption upper limit value.

Step S402: When the estimated delivery cost is less than or equal to the estimated consumption upper limit value, determining that the weight function is a first monotonic function used to identify a positive correlation between the delivery cost and the weight information.

Step S403: When the estimated delivery cost is greater than the estimated consumption upper limit value, determining that the weight function is a second monotonic function used to identify a positive correlation between the delivery cost and the weight information, where the first monotonic function is different from the second monotonic function.

After obtaining the estimated consumption upper limit value, the estimated delivery cost corresponding to the advertisement delivery plan can be analyzed and compared with the estimated consumption upper limit value. When the estimated delivery cost is less than or equal to the estimated consumption upper limit value, it indicates that the estimated delivery cost at this time is relatively small, that is, there is still a large room for the delivery cost to rise. At this time, the advertisement delivery effect (weight information) can increase significantly with the increase of the delivery cost, so it can be determined that the weight function is a first monotonic function used to identify a positive correlation between the delivery cost and the delivery weight.

Correspondingly, when the estimated delivery cost is greater than the estimated consumption upper limit value, it indicates that the room for the delivery cost to rise is limited. However, if the user continues to increase the estimated delivery cost, the advertisement delivery effect will increase slowly relative to the change degree of the advertisement delivery effect in the first monotonic function, and thus it can be determined that the weight function is a second monotonic function used to identify a positive correlation between the delivery cost and the weight information.

It should be noted that the first monotonic function is different from the second monotonic function. Specifically, the change degree corresponding to the first monotonic function is greater than the change degree corresponding to the second monotonic function. For example, the weight function can be expressed as the following formula:

$$f = \{ \begin{matrix}\frac{x}{max\_cost} , x \leq max\_cost \\ 1 + c * ( 1 - \frac{max\_cost}{x} ) , x > max\_cost\end{matrix}$$

where ƒ is the weight information, x is the estimated delivery cost, max_cost is the estimated consumption upper limit value, and c is a preset function parameter. When the estimated delivery cost x increases by the same degree, the increase degree of the weight information obtained through the first monotonic function

$$f = \frac{x}{max\_cost}$$

is p1, and the increase degree of the weight information obtained through the second monotonic function

$$f = 1 + c * ( 1 - \frac{max\_cost}{x} )$$

is p2, where the above p1 is greater than p2.

In this embodiment, by obtaining the estimated consumption upper limit value corresponding to the advertisement delivery plan, when the estimated delivery cost is less than or equal to the estimated consumption upper limit value, it can be determined that the weight function is a first monotonic function used to identify a positive correlation between the delivery cost and the weight information; when the estimated delivery cost is greater than the estimated consumption upper limit value, it can be determined that the weight function is a second monotonic function used to identify a positive correlation between the delivery cost and the weight information. This effectively realizes that different weight functions can be determined in different application scenarios, and then the weight function can be used to stably predict the advertisement delivery effect, further ensuring the accuracy and rationality of predicting the advertisement delivery effect.

FIG. 5 is a schematic flowchart of yet another method for predicting advertisement delivery effect provided by an embodiment of the present invention; based on any of the above embodiments, referring to FIG. 5, after determining the advertisement delivery effects respectively corresponding to different delivery costs, this embodiment may further include a technical solution for judging whether the advertisement delivery effect can be obtained. Specifically, the method may include:

Step S501: obtaining a bid lower limit value corresponding to the advertisement delivery plan.

For the advertisement delivery effects corresponding to different delivery costs, since the advertisement delivery effect may not be obtained because the delivery bid is small, and the advertisement delivery effect may be obtained because the delivery bid is large, in order to accurately determine whether the advertisement delivery effect can be obtained, the bid lower limit value corresponding to the advertisement delivery plan may be obtained. For the bid lower limit value, different methods may be used to obtain the bid lower limit value in different application scenarios. In some examples, the advertisement delivery plan may include the bid lower limit value. In this case, after obtaining the advertisement delivery plan, an information extraction operation may be performed on the advertisement delivery plan, so that the bid lower limit value corresponding to the advertisement delivery plan can be obtained.

In other examples, the advertisement delivery plan may not include the bid lower limit value. In this case, the bid lower limit value may be obtained by analyzing and processing an exposure lower limit parameter and a historical click-through rate corresponding to a product to be promoted. In this case, obtaining the bid lower limit value corresponding to the advertisement delivery plan may include: obtaining the exposure lower limit parameter and the historical click-through rate corresponding to the product to be promoted through a product exposure log; and determining the bid lower limit value corresponding to the advertisement delivery plan based on the exposure lower limit parameter and the historical click-through rate.

Specifically, the bid lower limit value may be estimated and obtained through historical data. The historical data may include the historical click-through rate and historical exposure parameters. In order to accurately determine the bid lower limit value, the product exposure log may be obtained first, and then the exposure parameters and the historical click-through rate of the product to be promoted within a period of time are statistically analyzed through the product exposure log. Since the exposure parameters corresponding to different time points in the period of time are different, the number of exposure parameters included in the product exposure log may be multiple. In order to obtain the bid lower limit value, the multiple exposure parameters may be analyzed and compared to obtain the exposure lower limit parameter among the multiple exposure parameters. The exposure lower limit parameter is used to indicate a minimum exposure value when performing promotion exposure on the product to be promoted.

After obtaining the exposure lower limit parameter and the historical click-through rate, the exposure lower limit parameter and the historical click-through rate may be analyzed and processed to obtain the bid lower limit value. In some examples, a pre-trained machine learning model or neural network model may be used to analyze and process the exposure lower limit parameter and the historical click-through rate, so that the bid lower limit value corresponding to the advertisement delivery plan output by the machine learning model or neural network model can be obtained. In other examples, determining the bid lower limit value corresponding to the advertisement delivery plan based on the exposure lower limit parameter and the historical click-through rate may include: determining a ratio of the exposure lower limit parameter to the historical click-through rate as the bid lower limit value corresponding to the advertisement delivery plan. For example, when the exposure lower limit parameter is min_rankscore and the historical click-through rate is ctr, the bid lower limit value may be obtained through min_bid=min_rankscore/ctr, where min_bid is the bid lower limit value, thereby effectively ensuring the accuracy and reliability of determining the bid lower limit value.

Step S502: determining delivery bids respectively corresponding to different delivery costs.

Since the obtained advertisement delivery effect corresponds to different delivery costs, and different delivery costs may include different delivery bids, in order to accurately determine whether the advertisement delivery effect can be obtained, delivery bids respectively corresponding to different delivery costs can be obtained. In some examples, the different delivery costs include the delivery bids; in this case, the delivery bids can be obtained by performing an information extraction operation on the delivery costs.

Step S503: when the delivery bid is greater than or equal to a bid lower limit value, determining a first identifier corresponding to the advertisement delivery effect, where the first identifier is used to indicate that the advertisement delivery effect can be obtained.

Step S504: when the delivery input information is less than the bid lower limit value, determining a second identifier corresponding to the advertisement delivery effect, where the second identifier is used to indicate that the advertisement delivery effect cannot be obtained.

After obtaining the delivery bid and the bid lower limit value, the delivery bid and the bid lower limit value can be analyzed and compared. When the delivery bid is greater than or equal to the bid lower limit value, it indicates that the delivery bid is relatively large; in this case, a normal delivery operation can be performed for the advertisement delivery plan, and an advertisement delivery effect corresponding to the delivery cost can be obtained, that is, the advertisement delivery effect can be obtained at this time, and thereby a first identifier corresponding to the advertisement delivery effect can be determined, where the first identifier is used to indicate that the advertisement delivery effect can be obtained. Specifically, the first identifier may be “0” or “1”.

Correspondingly, when the delivery bid is less than the bid lower limit value, it indicates that the delivery bid is relatively small; in this case, the normal delivery operation may not be able to be performed for the advertisement delivery plan, and the advertisement delivery effect corresponding to the delivery cost cannot be obtained at this time, that is, the advertisement delivery effect cannot be obtained at this time, and thereby a second identifier corresponding to the advertisement delivery effect can be determined, where the second identifier is used to indicate that the advertisement delivery effect cannot be obtained. Specifically, the second identifier may be “1” or “0”. It should be noted that the first identifier is different from the second identifier.

In this embodiment, by obtaining a bid lower limit value corresponding to the advertisement delivery plan, delivery bids respectively corresponding to different delivery costs are determined. When the delivery bid is greater than or equal to the bid lower limit value, a first identifier corresponding to the advertisement delivery effect is determined. When the delivery input information is less than the bid lower limit value, a second identifier corresponding to the advertisement delivery effect is determined. This effectively realizes that through the obtained first identifier and second identifier, the user can accurately and quickly determine whether the advertisement delivery effect can be obtained, and through the obtained first identifier and second identifier, it is helpful to assist the user in making advertisement promotion decisions, further improving the practicality of the method.

In specific applications, in order to solve the problems of insufficient confidence of advertisers in advertisement promotion plans and high trial-and-error costs existing in the related art, this application embodiment provides a method for estimating advertisement promotion effect. This method can directly display the advertisement promotion effect corresponding to the advertisement promotion plan after the advertiser sets the advertisement promotion plan and before formal delivery. The advertisement promotion effect is a predicted future effect, which is helpful to assist the advertiser in making promotion decisions. This can not only improve the efficiency of the advertisement promotion plan, but also help to promote website activity and increase platform revenue.

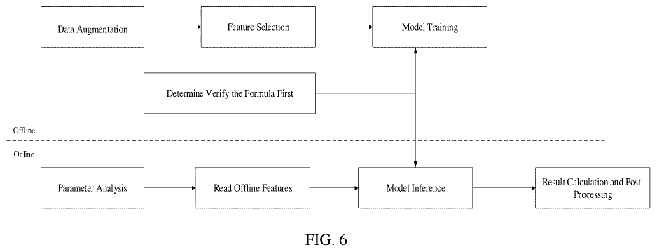

Referring to FIG. 6, the method may include performing a training operation of a network model offline and an operation of determining an advertisement promotion effect based on the network model. Taking

$${y}_{i} = exp ( {a}_{i} - {b}_{i} / x ) = {e}^{{a}_{i} - \frac{{b}_{i}}{x}}$$

as an advertisement delivery based on the network model. Taking function and

$$f = \{ \begin{matrix}\frac{x}{max\_cost} , x \leq max\_cost \\ 1 + c * ( 1 - \frac{max\_cost}{x} ) , x > max\_cost\end{matrix}$$

as a
weight function as an example below, the training operation of the network model in this embodiment may include the following steps:

Step 1: determining an advertisement delivery function and a weight function used for determining the advertisement promotion effect.

Regarding the advertisement delivery function and the weight function, the advertisement delivery function and the weight function can be determined according to manual experience or historical empirical data, where the advertisement delivery function is used to define an association relationship between the advertisement delivery bid and the advertisement delivery effect. In some examples, the advertisement delivery function may be

$${y}_{i} = exp ( {a}_{i} - {b}_{i} / x ) = {e}^{{a}_{i} - \frac{{b}_{i}}{x}} ,$$

where yᵢ is the advertisement delivery effect, which may include an exposure amount, a click amount, a consumption amount, etc. Specifically, the exposure amount delivery function may be

$${y}_{1} = exp ( {a}_{1} - {b}_{1} / x ) = {e}^{{a}_{1} - \frac{{b}_{1}}{x}} ,$$

the click amount delivery function may be

$${y}_{2} = exp ( {a}_{2} - {b}_{2} / x ) = {e}^{{a}_{2} - \frac{{b}_{2}}{x}} ,$$

and the consumption amount delivery function may be

$${y}_{3} = exp ( {a}_{3} - {b}_{3} / x ) = {e}^{{a}_{3} - \frac{{b}_{3}}{x}} .$$

Parameters (aᵢ, bᵢ) corresponding to the above different advertisement delivery functions may be different. The above parameter aᵢ can affect estimated maximum effect data, that is, an effect obtained when the advertisement delivery bid is infinite. The parameter bᵢ can affect a slope of the function, that is, a degree of change of the effect with the bid. When the advertisement delivery bid xᵢ approaches 0, the obtainable effect is also very small; when the advertisement delivery bid xᵢ gradually increases, the slope of the function increases rapidly, and the obtainable effect also increases rapidly when a unit bid is increased. It should be noted that when the advertisement delivery bid continues to increase and is considered to achieve a top highest bid in similar plans, since there is no continued competition space, an effect improvement speed will also decrease.

In addition, regarding the weight function, the weight function can be determined according to manual experience and historical empirical data. The weight function can be represented as a piecewise function. Specifically, the piecewise function may be

$$f = \{ \begin{matrix}\frac{x}{max\_cost} , x \leq max\_cost \\ 1 + c * ( 1 - \frac{max\_cost}{x} ) , x > max\_cost\end{matrix} ,$$

where ƒ is weight information, x is an estimated delivery budget, and max_cost is an estimated consumption amount upper limit value. In some examples, max_cost can be obtained through a preset formula

$$max\_cost = {e}^{{a}_{3} - \frac{{b}_{3}}{x}} ,$$

where c is a preset weight function parameter. It can be known from the above weight function that when the estimated delivery budget is less than or equal to the estimated consumption amount upper limit value, the weight information will linearly affect a final effect; when the estimated delivery budget is greater than the estimated consumption amount upper limit value, the weight information will be slowly increased as the estimated delivery budget increases. This can not only reduce the influence of a decrease in competitiveness caused by other promotion plans reaching the limit early, but also increase the motivation of an advertiser to increase the budget.

Step 2: obtaining training data, and performing augmentation processing on the training data to obtain augmented data.

The obtained training data may include historical advertisement delivery plans and historical advertisement delivery effects corresponding to the historical advertisement delivery plans. The historical advertisement delivery plans may include historical delivery budgets and historical delivery bids. Since bid modification behaviors rarely exist in real data of the historical advertisement delivery plans, the quantity of obtained training data is limited at this time. When a training operation of a machine learning model is performed based on a limited quantity of training data, the training effect of the machine learning model cannot be guaranteed. The machine learning model is used to determine delivery function parameters (a, b) in the advertisement delivery function and a weight function parameter c in the weight function under conditions of different advertisement delivery bids. Since the model training effect of the machine learning model cannot be guaranteed, the delivery function parameters and the weight function parameter corresponding to different advertisement delivery bids cannot be accurately learned and analyzed.

In order to solve the above technical problem and guarantee the training quality and effect of the machine learning model, after obtaining the training data, augmentation processing can be performed on the training data. In some examples, log data is used to perform a simulation operation on advertisement delivery effects corresponding to different advertisement delivery bids. Specifically, by simulating modification of the advertisement delivery bid in the advertisement plan, effect data such as the exposure amount, the click amount, and the consumption amount corresponding to different advertisement delivery bids is obtained by statistics, that is, the simulation operation of different advertisement delivery bids and advertisement delivery effects based on the log data is implemented, the data augmentation processing is completed, and the augmented data can be successfully obtained. The obtained augmented data and the training data can be collectively used as model training data, thereby effectively implementing an expansion operation on the model training data.

It should be noted that when performing the simulation modification operation on the advertisement delivery bid in the advertisement delivery plan, the modification magnitude corresponding to existing training data is different in different application scenarios. Specifically, when a promotion platform is relatively large and has many users, since data diversity and personalization are high, the modification magnitude of the advertisement delivery bid in the existing training data can be determined as finer modification parameters, which can guarantee the learning quality and effect of the machine learning model; in this case, the quantity of augmented data obtained after the modification simulation operation is relatively large. When the promotion platform is relatively small and has fewer users, since data diversity and personalization are limited, the modification magnitude of the advertisement delivery bid in the existing training data can be determined as coarser modification parameters; in this case, the quantity of augmented data obtained is relatively small.

In addition, in order to guarantee the quality and efficiency of the model training data, a minimum ranking score capable of exposure can be obtained through results in an advertisement item exposure log. The minimum ranking score may be min_rankscore=min (ctr*bid). A minimum exposure bid min_bid=min_rankscore/ctr can be determined through the above formula. It should be noted that the above minimum exposure bid can determine whether an advertisement item corresponding to a certain advertisement delivery bid can obtain exposure. Specifically, when the advertisement delivery bid is less than or equal to the minimum exposure bid, it indicates that the advertisement item corresponding to the advertisement delivery bid at this time cannot obtain this exposure, that is, the advertisement promotion effect corresponding to the advertisement delivery bid can be obtained; when the advertisement delivery bid is greater than the minimum exposure bid, it indicates that the advertisement item corresponding to the advertisement delivery bid at this time can obtain this exposure, that is, the advertisement promotion effect corresponding to the advertisement delivery bid cannot be obtained.

Step 3: determining the training data and the augmented data as model training data, and performing a feature extraction operation based on the model training data to obtain model training features.

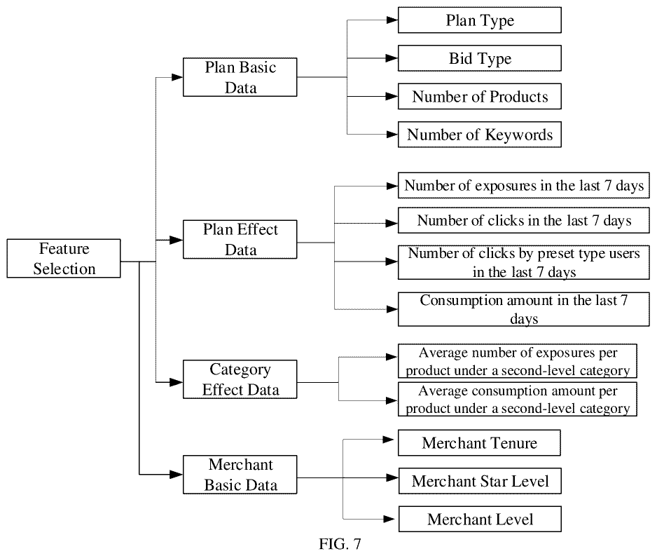

Specifically, the model training features may include four major categories of features. The four major categories of features may respectively include: plan basic data, plan effect data, category effect data, and merchant basic data. Referring to FIG. 7, the plan basic data may include: plan type (new product plan, hot product plan, ordinary product plan, keyword plan, etc.), bid type (industry intelligent bid, merchant manual bid, fixed bid, keyword bid, target cost bid, etc.), number of items, number of keywords, etc. The plan effect data may include: exposure count in the last 7 days, click count in the last 7 days, click count of preset type users in the last 7 days, consumption amount in the last 7 days, etc. The category effect data may include: average exposure count per item under a second-level category, average consumption per item under the second-level category. The merchant basic data may include: merchant tenure, merchant star level, merchant level, etc. By using a combination of basic data features (plan basic data and merchant basic data) and effect data (plan effect data and category effect data), it can be ensured that each advertiser selects different plan types, items, bidding methods, etc. according to requirements when creating an advertisement promotion plan, and diverse results can be displayed for different advertisement promotion plans. At the same time, historical effect data can also be used to improve the accuracy of the machine learning model in performing a parameter estimation operation.

Step 4: performing a model training operation based on the model training features and corresponding historical effect data to obtain the machine learning model.

The obtained machine learning model may be a multi-task learning model (Multi-gate MoE, MMOE for short). A training operation of multi-objective results can be implemented through the multi-task learning model. Specifically, delivery function parameters can be obtained through the machine learning model. The above delivery function parameters may include: parameters of an advertisement delivery exposure amount function, parameters of a click amount function, parameters of a consumption amount function, weight function parameters, etc. It should be noted that a parameter b in the delivery function parameters needs to be a positive number. Specifically, in order to ensure that the delivery function parameter b is a positive number, before outputting the delivery function parameter b, an activation function softplus can be used to process the delivery function parameter b, which can ensure the rationality of a model output result.

By determining the MMOE model as the machine learning model, since the MMOE model can enable multiple objectives to share parameters during training, and because there are associations between multiple training tasks, that is, expression manners of advertisement delivery functions corresponding to different effects are similar, when performing the training operation on the machine learning model, delivery function parameters respectively corresponding to advertisement delivery functions for different effects can be obtained at one time. That is, multiple results can be obtained with only one inference process. This has a great advantage when deploying the machine learning model, and can reduce computing resources required for data processing operations, improving the quality and efficiency of data processing.

Further, determining the advertisement promotion effect based on the network model may include the following steps:

Step 11: obtaining plan information corresponding to the advertisement promotion plan input by a user.

The client or the parsing front-end includes a performance estimation service for implementing an advertisement promotion effect estimation operation. The user can input the plan information through the client or the parsing front-end. The plan information may include at least one of the following: merchant ID, plan ID, promotion item ID, advertisement promotion bid, advertisement promotion budget, etc. In order to accurately implement the estimation operation of the advertisement promotion effect, the plan information can be converted into information recognizable by the performance estimation service, so that the performance estimation service can analyze and process the plan information to determine the advertisement promotion effect.

Step 12: obtaining offline features corresponding to the advertisement promotion plan based on the plan information.

After obtaining the merchant ID and the plan ID corresponding to the advertisement promotion plan, the offline features corresponding to the advertisement promotion plan can be queried according to information such as the merchant ID and the plan ID. The offline features may include at least one of the following: merchant consumption count in the last 30 days, plan promotion days, and other data. It should be noted that the offline features can be obtained by analyzing and processing the advertisement promotion plan in an offline scenario. The processing manner of offline features can reduce the amount of parameters required to be passed in when the client or the parsing front-end performs the advertisement promotion effect determination operation, and can further avoid overall service operation timeout, ensuring the quality and efficiency of data processing.

Step 13: after obtaining the offline features and the plan information, the offline features and the plan information can be analyzed and processed using the pre-trained machine learning model, thereby obtaining the delivery function parameters and the weight function parameters output by the machine learning model.

Specifically, after obtaining the plan information input by the client or the parsing front-end and the offline features queried offline, the plan information and the offline features can be input into the machine learning model to use the machine learning model to perform inference on the plan information and the offline features, thereby obtaining a series of target parameter values to be estimated, such as the delivery function parameters and the weight function parameters output by the machine learning model. The above delivery function parameters may include at least one of the following: parameters of the advertisement delivery exposure amount function, parameters of the click amount function, and parameters of the consumption amount function.

Step 14: determining the advertisement delivery effect corresponding to the advertisement promotion plan based on the delivery function parameters, the weight function parameters, the advertisement delivery function, and the weight function.

The estimated promotion budget in the advertisement promotion plan and the delivery function parameters are substituted into the advertisement delivery function to obtain a promotion effect; the estimated promotion budget in the advertisement promotion plan and the weight function parameters are substituted into the weight function to obtain weight information corresponding to the promotion effect; and then a product value of the promotion effect and the weight information is determined as the advertisement delivery effect corresponding to the advertisement promotion plan.

In addition, after obtaining the estimated promotion budget, the estimated promotion budget can also be adjusted to obtain multiple different promotion budgets. The different promotion budgets and the delivery function parameters are substituted into the advertisement delivery function to obtain promotion effects corresponding to the different promotion budgets and the weight function parameters are substituted into the weight function to obtain weight information corresponding to the different promotion budgets. Then, product values of the promotion effects corresponding to the different promotion budgets and the weight information are determined as advertisement delivery effects corresponding to the different promotion budgets.

After obtaining the advertisement delivery effect corresponding to the advertisement promotion plan and the advertisement delivery effects corresponding to the different promotion budgets, an encapsulation operation can be performed on all the advertisement delivery effects, and the encapsulated advertisement delivery effects are displayed through a display module of the client or the service front-end, so that the user can quickly and intuitively view all the advertisement delivery effects.

The technical solution provided by this application embodiment can not only provide advertisers with an effect estimation function before advertisement plan delivery to increase advertisers' delivery confidence, but also, in order to ensure the rationality of the estimation result, needs to ensure that the higher the advertisement bid and the higher the budget, the better the corresponding effect obtained. Specifically, in order to ensure the above principle, a monotonic prior function can be used as an analysis and processing function for determining the advertisement promotion effect, and a model can be used to estimate parameters in the prior function based on features of the advertisement plan. This can ensure both the accuracy of the estimation result and the rationality of the result. Specifically, when performing the estimation operation of the promotion effect for the advertisement promotion plan, it is only necessary to consider the features of the advertisement promotion plan itself to estimate the effect function parameters. After obtaining each function parameter, the promotion bid and promotion budget can be substituted into the function formula to calculate the advertisement promotion effect. In some examples, during the promotion process of the advertisement promotion effect, the value range of the parameters in the formula can be limited, thereby ensuring the monotonicity between the advertisement promotion effect and the bid and budget. In addition, through the piecewise function relationship between the advertisement promotion budget and the advertisement promotion effect, the rationality of the result when the budget increases can be effectively ensured, and then the total effect amount and the result distribution can be output independently. This helps to improve the scalability of the technical solution, further improves the practicality of the method, and facilitates market promotion and application.

FIG. 8 is a structural schematic diagram of an apparatus for predicting an advertisement delivery effect provided by an embodiment of the present invention. Referring to FIG. 8, this embodiment provides an apparatus for predicting an advertisement delivery effect. The apparatus for predicting an advertisement delivery effect is used to execute the method for predicting an advertisement delivery effect shown in FIG. 2 above. Specifically, the apparatus for predicting an advertisement delivery effect may include:
a first obtaining module 11, configured to obtain a plan identifier and an estimated delivery cost corresponding to an advertisement delivery plan;
a first determining module 12, configured to determine delivery function parameters in an advertisement delivery function and weight function parameters in a weight function based on the plan identifier and the estimated delivery cost, where the advertisement delivery function is used to identify a relationship between the delivery cost and a delivery effect, and the weight function is used to determine a weight of the delivery effect obtained through the advertisement delivery function;
a first processing module 13, configured to determine advertisement delivery effects respectively corresponding to different delivery costs based on the delivery function parameters, the weight function parameters, the advertisement delivery function, and the weight function before performing delivery for the advertisement delivery plan, where the different delivery costs at least include the estimated delivery cost.

In some examples, when the first determining module 12 determines the delivery function parameters in the advertisement delivery function and the weight function parameters in the weight function based on the plan identifier and the estimated delivery cost, the first determining module 12 is configured to perform: determining offline features corresponding to the advertisement delivery plan based on the plan identifier, where the offline features include: plan attributes, plan historical effects, and user attributes; and determining the delivery function parameters in the advertisement delivery function and the weight function parameters in the weight function based on the estimated delivery cost and the offline features.

In some examples, when the first processing module 13 determines the advertisement delivery effects respectively corresponding to the different delivery costs based on the delivery function parameters, the weight function parameters, the advertisement delivery function, and the weight function, the first processing module 13 is configured to perform: determining multiple different delivery costs based on the estimated delivery cost; determining delivery effects respectively corresponding to the different delivery costs based on the delivery function parameters and the advertisement delivery function; determining weight information respectively corresponding to the different delivery costs based on the weight function parameters and the weight function; and determining the advertisement delivery effects respectively corresponding to the different delivery costs based on the delivery effects and the weight information.

In some examples, when the first processing module 13 determines the advertisement delivery effects respectively corresponding to the different delivery costs based on the delivery effects and the weight information, the first processing module 13 is configured to perform: determining product values of the delivery effects corresponding to the different delivery costs multiplying the weight information as the advertisement delivery effects respectively corresponding to the different delivery costs.

In some examples, when the first processing module 13 determines the advertisement delivery effects respectively corresponding to the different delivery costs based on the delivery effects and the weight information, the first processing module 13 is configured to perform: obtaining delivery auxiliary parameters corresponding to the advertisement delivery plan, where the delivery auxiliary parameters include at least one of the following: a delivery time parameter, a delivery region parameter, and a delivery crowd parameter; and determining product values by multiplying the delivery effects respectively corresponding to the different delivery costs, the weight information, and the delivery auxiliary parameters as the advertisement delivery effects respectively corresponding to the different delivery costs.

In some examples, the advertisement delivery function is a monotonic function used to identify that a positive correlation exists between the delivery cost and the delivery effect; the delivery cost includes a delivery budget; and the delivery effect includes at least one of the following: an exposure amount, a click amount, and a consumption amount.

In some examples, the delivery function parameters include a first parameter used for defining an upper limit value of the delivery effect and a second parameter used for defining a rate of change of the advertisement delivery function; and the weight function parameters include a third parameter used for defining an upper limit value of the weight.

In some examples, the first obtaining module 11 and the first processing module 13 in this embodiment are configured to perform the following steps:
the first obtaining module 11, configured to obtain an estimated consumption upper limit value corresponding to the advertisement delivery plan;
the first processing module 13, configured to determine that the weight function is a first monotonic function used to identify a positive correlation between the delivery cost and the weight information when the estimated delivery cost is less than or equal to the estimated consumption upper limit value; and determine that the weight function is a second monotonic function used to identify a positive correlation between the delivery cost and the weight information when the estimated delivery cost is greater than the estimated consumption upper limit value, where the first monotonic function is different from the second monotonic function.

In some examples, when the first obtaining module 11 obtains the estimated consumption upper limit value corresponding to the advertisement delivery plan, the first obtaining module 11 is configured to perform: obtaining a consumption function corresponding to the advertisement delivery plan and a function parameter corresponding to the consumption function; and determining the estimated consumption upper limit value corresponding to the advertisement delivery plan based on the consumption function, the function parameter, and the estimated delivery cost.

In some examples, after determining the advertisement delivery effects respectively corresponding to different delivery costs, the first obtaining module 11, the first determining module 12, and the first processing module 13 in this embodiment are configured to perform the following steps:
the first obtaining module 11, configured to obtain a bid lower limit value corresponding to the advertisement delivery plan;
the first determining module 12, configured to determine delivery bids respectively corresponding to different delivery costs;
the first processing module 13, configured to determine a first identifier corresponding to the advertisement delivery effect when the delivery bid is greater than or equal to the bid lower limit value, where the first identifier is used to identify that the advertisement delivery effect can be obtained; and determine a second identifier corresponding to the advertisement delivery effect when the delivery input information is less than the bid lower limit value, where the second identifier is used to identify that the advertisement delivery effect cannot be obtained.

In some examples, when the first obtaining module 11 obtains the bid lower limit value corresponding to the advertisement delivery plan, the first obtaining module 11 is configured to perform: obtaining an exposure lower limit parameter and a historical click-through rate corresponding to a commodity to be promoted through a commodity exposure log; and determining the bid lower limit value corresponding to the advertisement delivery plan based on the exposure lower limit parameter and the historical click-through rate.

The apparatus shown in FIG. 8 can execute the methods of the embodiments shown in FIG. 1 to FIG. 7. For parts not described in detail in this embodiment, reference may be made to relevant descriptions of the embodiments shown in FIG. 1 to FIG. 7. For the execution process and technical effects of this technical solution, refer to the descriptions in the embodiments shown in FIG. 1 to FIG. 7, which are not repeated here.

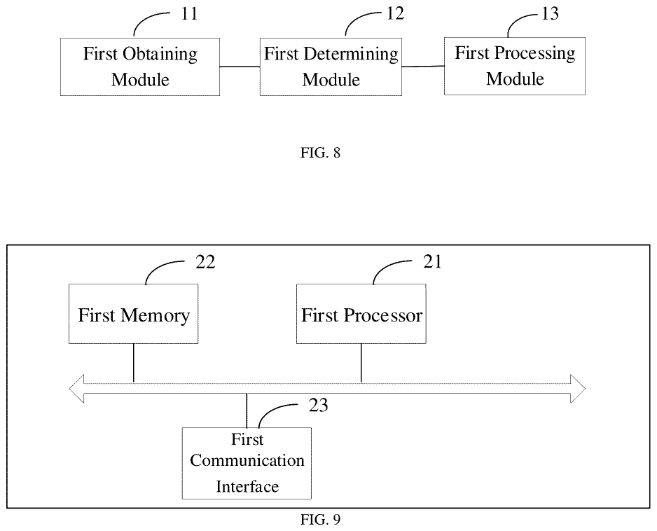

In a possible design, the structure of the apparatus for predicting an advertisement delivery effect shown in FIG. 8 can be implemented as an electronic device, and the electronic device may be various devices such as a controller, a personal computer, or a server. As shown in FIG. 9, the electronic device may include: a first processor 21 and a first memory 22. The first memory 22 is used to store a program of the method for predicting an advertisement delivery effect provided in the embodiments shown in FIG. 1 to FIG. 7 above to be executed by the corresponding electronic device, and the first processor 21 is configured to execute the program stored in the first memory 22.

The program includes one or more computer instructions, where when the one or more computer instructions are executed by the first processor 21, the following steps can be implemented: obtaining a plan identifier and an estimated delivery cost corresponding to an advertisement delivery plan; determining delivery function parameters in an advertisement delivery function and weight function parameters in a weight function based on the plan identifier and the estimated delivery cost, where the advertisement delivery function is used to identify a relationship between the delivery cost and a delivery effect, and the weight function is used to determine a weight of the delivery effect obtained through the advertisement delivery function; and determining advertisement delivery effects respectively corresponding to different delivery costs based on the delivery function parameters, the weight function parameters, the advertisement delivery function, and the weight function before performing delivery for the advertisement delivery plan, where the different delivery costs at least include the estimated delivery cost.

Further, the first processor 21 is further configured to execute all or part of the steps in the embodiments shown in FIG. 1 to FIG. 7 described above.

The structure of the electronic device may further include a first communication interface 23, used for the electronic device to communicate with other devices or a communication network.

In addition, an embodiment of the present invention provides a computer storage medium, used for storing computer software instructions used by an electronic device, which contains the FIG. 1 to FIG. 7 shown embodiments advertisement delivery effect prediction method program involved.

In addition, an embodiment of the present invention provides a computer program product, comprising: a computer-readable storage medium storing computer instructions, where when the computer instructions are executed by one or more processors, the one or more processors are caused to execute the FIG. 1 to FIG. 7 shown method embodiments advertisement delivery effect prediction method steps.

The device embodiments described above are merely illustrative. The units described as separate parts may or may not be physically separate, and the parts displayed as units may or may not be physical units, that is, may be located in one place, or may be distributed on multiple network units. Some or all of the modules may be selected according to actual needs to achieve the objectives of the solutions of the embodiments. A person of ordinary skill in the art can understand and implement them without creative efforts.

Through the description of the above embodiments, a person skilled in the art can clearly understand that each embodiment can be implemented by means of a necessary general hardware platform, and of course, can also be implemented by means of a combination of hardware and software. Based on such understanding, the above technical solutions essentially or the part contributing to the prior art can be embodied in the form of a computer product. The present invention can be in the form of a computer program product implemented on one or more computer-usable storage media (including but not limited to a disk memory, a CD-ROM, an optical memory, etc.) containing computer-usable program code.

The present invention is described with reference to flowcharts and/or block diagrams of the method, device (system), and computer program product according to the embodiments of the present invention. It should be understood that computer program instructions can implement each process and/or block in the flowcharts and/or block diagrams, and a combination of processes and/or blocks in the flowcharts and/or block diagrams. These computer program instructions can be provided to a processor of a general-purpose computer, a special-purpose computer, an embedded processor, or other programmable devices to generate a machine, so that the instructions executed by the processor of the computer or other programmable devices generate a device for implementing functions specified in one or more processes in the flowcharts and/or one or more blocks in the block diagrams.

These computer program instructions may also be stored in a computer-readable memory capable of guiding a computer or other programmable devices to work in a specific manner, so that the instructions stored in the computer-readable memory generate a manufactured product including an instruction device, and the instruction device implements functions specified in one or more processes in the flowcharts and/or one or more blocks in the block diagrams. These computer program instructions may also be loaded onto a computer or other programmable devices, so that a series of operation steps are performed on the computer or other programmable devices to generate processing implemented by the computer, and thus the instructions executed on the computer or other programmable devices provide steps for implementing functions specified in one or more processes in the flowcharts and/or one or more blocks in the block diagrams. In a typical configuration, a computing device includes one or more processors (CPU), an input/output interface, a network interface, and a memory. The memory may include a non-permanent memory in a computer-readable medium, a random access memory (RAM), and/or a non-volatile memory, such as a read-only memory (ROM) or a flash memory (flash RAM). The memory is an example of a computer-readable medium.

Computer-readable media include permanent and non-permanent, removable and non-removable media, which can implement information storage by any method or technology. The information may be computer-readable instructions, data structures, program modules, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, compact disc read-only memory (CD-ROM), digital versatile disc (DVD) or other optical storage, magnetic cassette tape, magnetic tape magnetic disk storage or other magnetic storage devices, or any other non-transmission media, which can be used to store information that can be accessed by a computing device. According to the definition herein, computer-readable media do not include transitory computer-readable media (transitory media), such as modulated data signals and carrier waves.

Finally, it should be noted that the above embodiments are merely used to describe the technical solutions of the present invention, rather than limiting them. Although the present invention has been described in detail with reference to the foregoing embodiments, a person of ordinary skill in the art should understand that they can still modify the technical solutions described in the foregoing embodiments, or make equivalent replacements to some technical features therein. However, these modifications or replacements do not make the essence of the corresponding technical solutions depart from the spirit and scope of the technical solutions of the embodiments of the present invention.

1. A method for predicting advertisement delivery effect, comprising:
obtaining a plan identifier and an estimated delivery cost corresponding to an advertisement delivery plan;
determining a delivery function parameter in an advertisement delivery function and a weight function parameter in a weight function based on the plan identifier and the estimated delivery cost, wherein the advertisement delivery function is used to identify a relationship between a delivery cost and a delivery effect, and the weight function is used to determine a weight of the delivery effect obtained through the advertisement delivery function; and
determining advertisement delivery effects respectively corresponding to different delivery costs based on the delivery function parameter, the weight function parameter, the advertisement delivery function, and the weight function before delivering the advertisement delivery plan, wherein the different delivery costs at least include the estimated delivery cost.

2. The method of claim 1, wherein determining delivery function parameters in an advertisement delivery function and weight function parameters in a weight function based on the plan identifier and the estimated delivery cost comprises:
determining offline features corresponding to the advertisement delivery plan based on the plan identifier, wherein the offline features comprise: plan attributes, plan historical performance, and user attributes;
determining the delivery function parameters in the advertisement delivery function and the weight function parameters in the weight function based on the estimated delivery cost and the offline features.

3. The method of claim 1, wherein determining advertisement delivery effects respectively corresponding to different delivery costs based on the delivery function parameter, the weight function parameter, the advertisement delivery function, and the weight function comprises:
determining a plurality of different delivery costs based on the estimated delivery cost;
determining delivery effects respectively corresponding to the different delivery costs based on the delivery function parameter and the advertisement delivery function;
determining weight information respectively corresponding to the different delivery costs based on the weight function parameter and the weight function;
determining advertisement delivery effects respectively corresponding to the different delivery costs based on the delivery effects and the weight information.

4. The method of claim 3, wherein determining advertisement delivery effects respectively corresponding to different delivery costs based on the delivery effects and the weight information comprises:
determining product values of the delivery effects corresponding to the different delivery costs multiplying the weight information as the advertisement delivery effects respectively corresponding to the different delivery costs.

5. The method of claim 3, wherein determining advertisement delivery effects respectively corresponding to different delivery costs based on the delivery effects and the weight information comprises:
obtaining delivery auxiliary parameters corresponding to the advertisement delivery plan, wherein the delivery auxiliary parameters comprise at least one of the following: a delivery time parameter, a delivery region parameter, or a delivery audience parameter;
determining product values by multiplying the delivery effects respectively corresponding to the different delivery costs, the weight information, and the delivery auxiliary parameters as the advertisement delivery effects respectively corresponding to the different delivery costs.

6. The method of claim 1, wherein
the advertisement delivery function is a monotonic function for indicating that a positive correlation exists between delivery cost and delivery effect; the delivery cost comprises a delivery budget; and the delivery effect comprises at least one of the following: exposure amount, click amount, or consumption amount.

7. The method of claim 1, wherein
the delivery function parameter comprises a first parameter for defining an upper limit value of the delivery effect and a second parameter for defining a rate of change of the advertisement delivery function; and the weight function parameter comprises a third parameter for defining an upper limit value of the weight.

8. The method of claim 1, wherein the method further comprises:
obtaining an estimated consumption amount upper limit value corresponding to the advertisement delivery plan;
determining that the weight function is a first monotonic function for indicating that a positive correlation exists between delivery cost and weight information when the estimated delivery cost is less than or equal to the estimated consumption amount upper limit value;
determining that the weight function is a second monotonic function for indicating that a positive correlation exists between delivery cost and weight information when the estimated delivery cost is greater than the estimated consumption amount upper limit value, wherein the first monotonic function is different from the second monotonic function.

9. The method of claim 8, wherein obtaining the estimated consumption amount upper limit value corresponding to the advertisement delivery plan comprises:
obtaining a consumption amount function corresponding to the advertisement delivery plan and a function parameter corresponding to the consumption amount function;
determining the estimated consumption amount upper limit value corresponding to the advertisement delivery plan based on the consumption amount function, the function parameter, and the estimated delivery cost.

10. The method of claim 1, wherein after determining the advertisement delivery effects respectively corresponding to different delivery costs, the method further comprises:
obtaining a bid lower limit value corresponding to the advertisement delivery plan;
determining delivery bids respectively corresponding to different delivery costs;
determining a first identifier corresponding to the advertisement delivery effect when the delivery bid is greater than or equal to the bid lower limit value, wherein the first identifier is used to indicate that the advertisement delivery effect is obtainable;
determining a second identifier corresponding to the advertisement delivery effect when the delivery input information is less than the bid lower limit value, wherein the second identifier is used to indicate that the advertisement delivery effect is not obtainable.

11. The method of claim 10, wherein obtaining the bid lower limit value corresponding to the advertisement delivery plan comprises:
obtaining an exposure lower limit parameter and a historical click-through rate corresponding to a product to be promoted through a product exposure log;
determining the bid lower limit value corresponding to the advertisement delivery plan based on the exposure lower limit parameter and the historical click-through rate.

12. A non-transitory computer-readable storage medium configured with instructions executable by one or more processors to cause the one or more processors to perform operations comprising:
obtaining a plan identifier and an estimated delivery cost corresponding to an advertisement delivery plan;
determining a delivery function parameter in an advertisement delivery function and a weight function parameter in a weight function based on the plan identifier and the estimated delivery cost, wherein the advertisement delivery function is used to identify a relationship between a delivery cost and a delivery effect, and the weight function is used to determine a weight of the delivery effect obtained through the advertisement delivery function; and
determining advertisement delivery effects respectively corresponding to different delivery costs based on the delivery function parameter, the weight function parameter, the advertisement delivery function, and the weight function before delivering the advertisement delivery plan, wherein the different delivery costs at least include the estimated delivery cost.

13. The non-transitory computer-readable storage medium of claim 12, wherein determining delivery function parameters in an advertisement delivery function and weight function parameters in a weight function based on the plan identifier and the estimated delivery cost comprises:
determining offline features corresponding to the advertisement delivery plan based on the plan identifier, wherein the offline features comprise: plan attributes, plan historical performance, and user attributes; and
determining the delivery function parameters in the advertisement delivery function and the weight function parameters in the weight function based on the estimated delivery cost and the offline features.

14. The non-transitory computer-readable storage medium of claim 12, wherein determining advertisement delivery effects respectively corresponding to different delivery costs based on the delivery function parameter, the weight function parameter, the advertisement delivery function, and the weight function comprises:
determining a plurality of different delivery costs based on the estimated delivery cost;
determining delivery effects respectively corresponding to the different delivery costs based on the delivery function parameter and the advertisement delivery function;
determining weight information respectively corresponding to the different delivery costs based on the weight function parameter and the weight function;
determining advertisement delivery effects respectively corresponding to the different delivery costs based on the delivery effects and the weight information.

15. The non-transitory computer-readable storage medium of claim 14, wherein determining advertisement delivery effects respectively corresponding to different delivery costs based on the delivery effects and the weight information comprises:
determining product values of the delivery effects corresponding to the different delivery costs multiplying the weight information as the advertisement delivery effects respectively corresponding to the different delivery costs.

16. The non-transitory computer-readable storage medium of claim 14, wherein determining advertisement delivery effects respectively corresponding to different delivery costs based on the delivery effects and the weight information comprises:
obtaining delivery auxiliary parameters corresponding to the advertisement delivery plan, wherein the delivery auxiliary parameters comprise at least one of the following: a delivery time parameter, a delivery region parameter, or a delivery audience parameter;
determining product values by multiplying the delivery effects respectively corresponding to the different delivery costs, the weight information, and the delivery auxiliary parameters as the advertisement delivery effects respectively corresponding to the different delivery costs.

17. The non-transitory computer-readable storage medium of claim 12, wherein
the advertisement delivery function is a monotonic function for indicating that a positive correlation exists between delivery cost and delivery effect; the delivery cost comprises a delivery budget; and the delivery effect comprises at least one of the following: exposure amount, click amount, or consumption amount.

18. The non-transitory computer-readable storage medium of claim 12, wherein
the delivery function parameter comprises a first parameter for defining an upper limit value of the delivery effect and a second parameter for defining a rate of change of the advertisement delivery function; and the weight function parameter comprises a third parameter for defining an upper limit value of the weight.

19. The non-transitory computer-readable storage medium of claim 12, wherein the method further comprises:
obtaining an estimated consumption amount upper limit value corresponding to the advertisement delivery plan;
determining that the weight function is a first monotonic function for indicating that a positive correlation exists between delivery cost and weight information when the estimated delivery cost is less than or equal to the estimated consumption amount upper limit value;
determining that the weight function is a second monotonic function for indicating that a positive correlation exists between delivery cost and weight information when the estimated delivery cost is greater than the estimated consumption amount upper limit value, wherein the first monotonic function is different from the second monotonic function.

20. An electronic device comprising:
one or more processors; and
one or more computer-readable memories coupled to the one or more processors and having instructions stored thereon that are executable by the one or more processors to perform one or more operations comprising:
obtaining a plan identifier and an estimated delivery cost corresponding to an advertisement delivery plan;
determining a delivery function parameter in an advertisement delivery function and a weight function parameter in a weight function based on the plan identifier and the estimated delivery cost, wherein the advertisement delivery function is used to identify a relationship between a delivery cost and a delivery effect, and the weight function is used to determine a weight of the delivery effect obtained through the advertisement delivery function; and
determining advertisement delivery effects respectively corresponding to different delivery costs based on the delivery function parameter, the weight function parameter, the advertisement delivery function, and the weight function before delivering the advertisement delivery plan, wherein the different delivery costs at least include the estimated delivery cost.
